(19) United States
(12) Patent Application Publication
(10) Pub. No.: US 2023/0284023 A1
(43) Pub. Date: Sep. 7, 2023

(54) CONTROL METHOD, CONTROL DEVICE, AND RECORDING MEDIUM

(71) Applicant: Panasonic Intellectual Property Corporation of America, Torrance, CA (US)

(72) Inventors: Ayaka MITANI, Osaka (JP); Naohisa NISHIDA, Osaka (JP); Yuji UNAGAMI, Osaka (JP); Kakuya YAMAMOTO, Hyogo (JP); Junichiro SOEDA, Nara (JP)

(21) Appl. No.: 18/197,940

(22) Filed: May 16, 2023

Related U.S. Application Data
(63) Continuation of application No. PCT/JP2021/037458, filed on Oct. 8, 2021.
(60) Provisional application No. 63/115,846, filed on Nov. 19, 2020.

(51) Int. Cl. H04W 12/08

(52) U.S. Cl. CPC H04W 12/08; H04B 5/0025

(57) ABSTRACT

A control method to be executed by a first device includes: receiving identification information identifying a second device from the second device by near-field communication; determining an evaluation value indicating appropriateness of the processing executed by the second device, with reference to a storage device that stores history information indicating processing executed by the second device; and restricting the near-field communication with the second device, based on the evaluation value determined.

### CROSS REFERENCE TO RELATED APPLICATIONS

This is a continuation application of PCT International Application No. PCT/JP2021/037458 filed on Oct. 8, 2021, designating the United States of America, which is based on and claims priority of U.S. Provisional Patent Application No. 63/115,846 filed on Nov. 19, 2020. The entire disclosures of the above-identified applications, including the specifications, drawings and claims are incorporated herein by reference in their entirety.

### FIELD

The present disclosure relates to a control method, a control device, and a recording medium.

### BACKGROUND

A technique allowing easier communications with other people, using a mobile information terminal by a near-field communication technology is disclosed (see, e.g., Patent Literature 1).

### CITATION LIST

### Patent Literature

PTL 1: Japanese Unexamined Patent Application Publication No. 2007-214968

### SUMMARY

Depending on the state of a terminal of a communication partner, however, inappropriate communications may occur through near-field communication.

To address the problem, the present disclosure provides a control method for reducing inappropriate communications through near-field communication.

A control method according to an aspect of the present disclosure is to be executed by a first device. The control method includes: receiving identification information identifying a second device from the second device through near-field communication; determining an evaluation value indicating appropriateness of processing executed by the second device, with reference to a storage device that stores history information indicating the processing executed by the second device; and restricting the near-field communication with the second device, based on the evaluation value determined.

The general and specific aspect may be implemented using a system, a device, an integrated circuit, a computer program, or a computer-readable recording medium such as a CD-ROM, or any combination of systems, devices, integrated circuits, computer programs, or recording media.

A control method according to the present disclosure reduces inappropriate communications through near-field communication.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 schematically illustrates a configuration of a management system according to an embodiment.

FIG. 2 schematically illustrates near-field communication between terminals according to the embodiment.

FIG. 3 is a block diagram schematically showing a configuration of each terminal according to the embodiment.

FIG. 4 illustrates a first example of reliability correspondence information according to the embodiment.

FIG. 5 illustrates a second example of the reliability correspondence information according to the embodiment.

FIG. 6 illustrates a third example of the reliability correspondence information according to the embodiment.

FIG. 7 is a first sequence diagram showing processing of the management system according to the embodiment.

FIG. 8 is a second sequence diagram showing the processing of the management system according to the embodiment.

FIG. 9 is a third sequence diagram showing the processing of the management system according to the embodiment.

FIG. 10 is a flowchart showing processing of the terminals for the near-field communication according to the embodiment.

FIG. 11 illustrates a first example of transaction data according to the embodiment.

FIG. 12 illustrates a second example of the transaction data according to the embodiment.

FIG. 13 schematically illustrates a configuration of a management system according to a variation of the embodiment.

FIG. 14 is a sequence diagram showing processing of the management system according to the variation of the embodiment.

FIG. 15 illustrates a data structure of a blockchain.

FIG. 16 illustrates a data structure of transaction data.

### DESCRIPTION OF EMBODIMENT

### (Underlying Knowledge Forming Basis of the Present Disclosure)

The present inventors have found that the following problem arises in the content providing technique described in the “Background”.

There is a technique allowing easier communications with other people, using a mobile information terminal through the near-field communication technology.

Assume that information is transmitted from a terminal to another terminal (i.e., the terminal of a communication partner) through near-field communication. An inappropriate communication partner may fraudulently leak the transmitted information.

Assume that a host terminal obtains information from a terminal of a communication partner through near-field communication. Containing inappropriate information, the obtained information may cause an undesired event on the host terminal or the terminal of the communication partner.

The inappropriate information contains, for example, software or data causing a problem at a terminal, or causing the terminal to access a fraudulent website or fraudulently access a website.

In this manner, a terminal may establish inappropriate communications through the near-field communication, depending on the state of the terminal of a communication partner.

To address the problem, the present disclosure provides a control method for reducing inappropriate communications through near-field communication.

In order to achieve the objective, a control method according to an aspect of the present disclosure is to be executed by a first device. The control method includes: receiving identification information identifying a second device from the second device through near-field communication; determining an evaluation value indicating appropriateness of processing executed by the second device, with reference to a storage device that stores history information indicating the processing executed by the second device; and restricting the near-field communication with the second device, based on the evaluation value determined.

In this aspect, the first device restricts the near-field communication with the second device, based on the appropriateness of the processing executed by the second device. This configuration reduces the risk of leaking information through transmission to the second device that has executed inappropriate processing. This configuration also reduces the risk of causing the first device to operate inappropriately upon receipt of the information from the second device that has executed inappropriate processing. On the other hand, the first device operates appropriately through communications via the second device that has executed appropriate processing. In this manner, the first device reduces inappropriate communications through the near-field communication.

For example, the higher an evaluation indicated by the evaluation value is, the less strict the restriction may be.

In this aspect, the first device restricts the near-field communication with the second device more strictly with a decrease in the appropriateness of the processing executed by the second device. This configuration reduces the risk of leaking information through transmission to the second device that has executed inappropriate processing. This configuration also reduces the risk of causing the first device to operate inappropriately upon receipt of the information from the second device that has executed inappropriate processing. On the other hand, the first device restricts the near-field communication with the second device more moderately with an increase in the appropriateness of the processing executed by the second device. Accordingly, the first device operates appropriately through communications via the second device that has executed appropriate processing. In this manner, the first device reduces inappropriate communications through the near-field communication.

For example, the restricting may include: allowing the near-field communication with the second device, when the evaluation value is higher than a threshold; and denying the near-field communication with the second device, when the evaluation value is lower than or equal to the threshold.

In this aspect, the first device allows or denies the near-field communication with the second device more easily, based on the threshold. Accordingly, the first device restricts inappropriate communications through the near-field communication more easily.

For example, the processing may include installation of an operating system by the second device. The determining may include: determining a higher evaluation value with an increase in a version of the operating system installed in the installation by the second device.

In this aspect, the first device determines the evaluation value of the second device more easily, based on the version of the operating system installed by the second device. Accordingly, the first device restricts inappropriate communications through the near-field communication more easily.

For example, the processing may include pairing for the near-field communication by the second device. The determining may include determining a higher evaluation value with an increase in a total number of partners paired with the second device.

In this aspect, the first device determines the evaluation value of the second device more easily, based on the number of the partners paired with the second device for the near-field communication. Accordingly, the first device restricts inappropriate communications through the near-field communication more easily.

For example, the processing may include downloading of content by the second device. The determining includes: determining a higher evaluation value with an increase in a total number of contents downloaded by the second device.

In this aspect, the first device determines the evaluation value of the second device more easily, based on the number of the contents downloaded by the second device. Accordingly, the first device restricts inappropriate communications through the near-field communication more easily.

For example, the control method described above may further include restricting execution of related processing that is related to the near-field communication with the second device, based on the evaluation value determined. The related processing may include: (a) reading data stored in a storage device of the first device, and transmitting the data to the second device; (b) writing the data received from the second device to the storage device of the first device; (c) accessing a sensor or a device of the first device, while the near-field communication with the second device is established; and (d) allowing or denying (a), (b), or (c) in advance.

In this aspect, the first device restricts the related processing, based on the appropriateness of the processing executed by the second device. Accordingly, the first device contributes to the reduction in inappropriate operations of the first device itself, while restricting inappropriate communications through the near-field communication.

For example, the restricting of the execution of the related processing may include: allowing the execution of the related processing, when the evaluation value is higher than a threshold; and denying the execution of the related processing, when the evaluation value is lower than or equal to the threshold.

In this aspect, the first device allows or denies the execution of the related processing more easily, based on the threshold.

Accordingly, the first device contributes to the reduction in inappropriate operations of the first device itself, while restricting inappropriate communications through the near-field communication.

For example, the threshold may be determined in accordance with software that is operating on the first device and communicating with the second device through the near-field communication, or processing that is executed by the first device and communicating with the near-field communication with the second device.

In this aspect, the first device allows or denies the execution of the related processing more easily, based on the threshold determined in accordance with the software or processing communicating with the second device through the near-field communication. Accordingly, the first device contributes to the reduction in inappropriate operations of the first device itself, while restricting inappropriate communications through the near-field communication.

For example, the control method described above may further include: causing the storage device to store new history information on processing newly executed by the second device, when the evaluation value is lower than or equal to the threshold.

In this aspect, the first device may cause the second device that has executed inappropriate processing to store new history information so as to increase the appropriateness of the processing executed by the second device. In this case, the first device may allow the near-field communication with the second device.

Accordingly, the first device has more opportunities to communicate with the second device through the near-field communication. The first device reduces inappropriate communications through the near-field communication and has more opportunities for appropriate communications.

For example, the first device and the second device may be included in a plurality of devices each having a distributed ledger for managing the history information. The first device may include the storage device. The determining may include: determining the evaluation value with reference to the history information stored in the storage device of the first device.

In this aspect, the first device evaluates the appropriateness of the processing executed by the second device, based on the evaluation value safely managed using the distributed ledger substantially without any falsification. The first device then restricts the near-field communication with the second device. Accordingly, the first device reduces inappropriate communications through the near-field communication, based on the evaluation value managed more safely.

A control device according to an aspect of the present disclosure serves as a first device. The control device includes: a processor; and a memory connected to the processor. Using the memory, the processor receives identification information identifying a second device from the second device through near-field communication, determines an evaluation value indicating appropriateness of processing executed by the second device, with reference to a storage device that stores history information indicating the processing executed by the second device; and restricts the near-field communication with the second device, based on the evaluation value determined.

This aspect provides at least the same advantageous effects as the control method.

A non-transitory computer-readable recording medium according to an aspect of the present disclosure is for use in a computer. The recording medium has recorded thereon a program for causing the computer to execute the control method described above.

This aspect provides at least the same advantageous effects as the control method.

These general and specific aspects may be implemented using a system, a device, an integrated circuit, a computer program, or a computer-readable recording medium such as a CD-ROM, or any combination of systems, devices, integrated circuits, computer programs, or recording media.

Now, an embodiment will be described in detail with reference to the drawings.

The exemplary embodiment described below shows a general or specific example. The numerical values, shapes, materials, elements, the arrangement and connection of the elements, steps, the processing order of the steps etc. shown in the following exemplary embodiment is a mere example, and therefore do not limit the scope of the present invention. Among the elements in the following exemplary embodiments, those not recited in any one of the independent claims with the broadest concept are described as optional elements.

### Embodiment

In this embodiment, a control method, for example, for reducing inappropriate communications through near-field communication will be described.

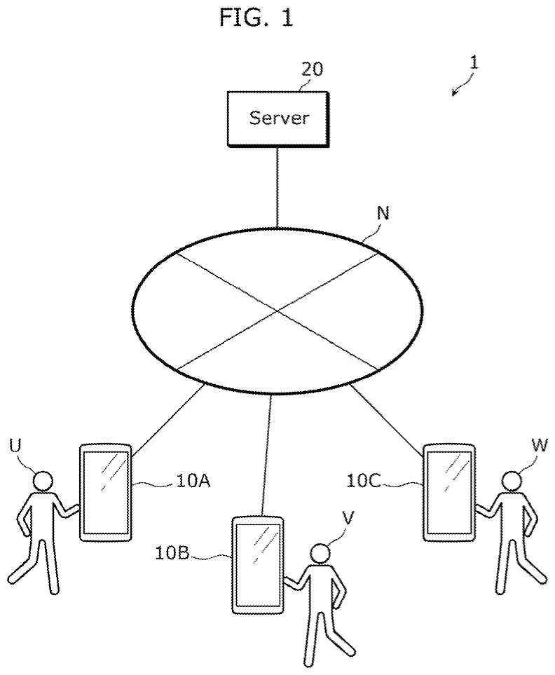

FIG. 1 schematically illustrates a configuration of management system 1 according to this embodiment.

As shown in FIG. 1, management system 1 includes terminals 10A, 10B, and 10C (also referred to as “terminal 1A and the other terminals”). Terminal 10A and the other terminals are connected to network N and communicative with each other through network N.

Management system 1 is connected to server 20. Server 20 provides an operating system (OS) package containing an OS.

Management system 1 is a distributed ledger system including plurality of terminals (i.e., terminal 10A and the other terminals), each having a distributed ledger. The distributed ledger is for managing the reliability of each terminal. The reliability is an evaluation value indicating the appropriateness of the processing executed by the terminal.

Terminal 10A is one of the plurality of terminals (i.e., terminal 10A and the other terminals), each having a distributed ledger, in management system 1. The distributed ledger of terminal 10A stores transaction data. The transaction data stored in the distributed ledger includes history information on the processing executed by the terminal and reliability correspondence information. The user of terminal 10A will also be referred to as “user U”.

Terminals 10B and 10C are devices with the same function as terminal 10A and operate independently from terminal 10A. The user of terminal 10B will also be referred to as “user V”, while the user of terminal 10C will also be referred to as “user W”.

While an example will be described in this embodiment where management system 1 includes three terminals (i.e., terminal 10A and the other terminals), management system 1 may include more terminals.

Network N my be any communication line or network. Examples may include the Internet, a mobile carrier network, an access network of an Internet provider, or a public access network.

Note that management system 1 may include server 20.

Server 20 may have a distributed ledger and constitute the distributed ledger system, together with terminal 10A and the other terminals.

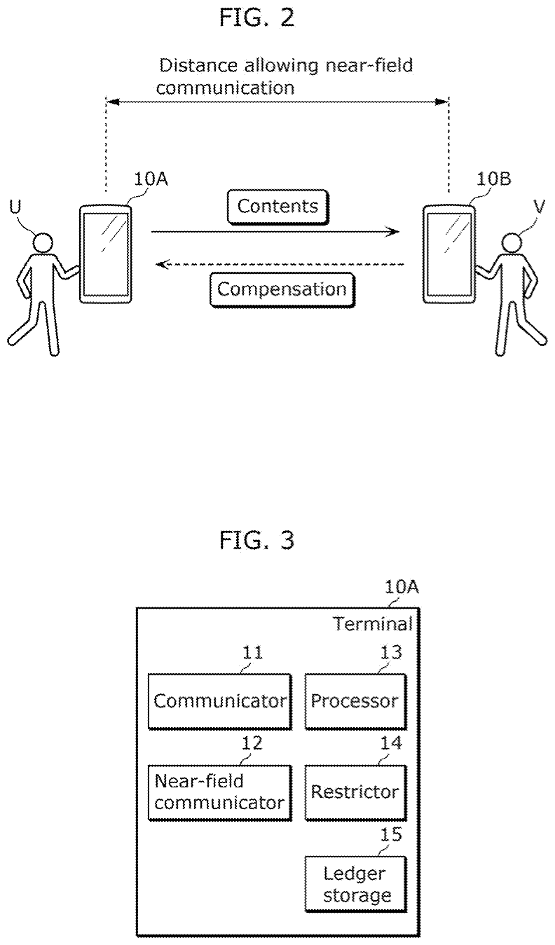

FIG. 2 schematically illustrates near-field communication between terminals according to this embodiment.

User U carries terminal 10A. User V carries terminal 10B.

Terminals 10A and 10B are carried by users U and V, respectively, and reach places where the near-field communication is possible. Terminals 10A and 10B then exchange information through the near-field communication.

The near-field communication shown in FIG. 2 is useful for providing contents, for example, from terminal 10A to terminal 10B. In this case, terminals 10A and 10B exchange information on the content provision. Based on the information, the contents are provided from user U to user V. At this time, compensation for the content provision may be provided from user V to user U. At this time, contents may also be provided from user V to user U.

Note that contents may be provided by causing a distributed ledger for managing the content owners to store transaction data for setting or changing the content owners. The compensation for the contents may be provided by causing a distributed ledger for managing the transfer of value information to store transaction data indicating the transfer of value information. Each distributed ledger may be included in management system 1.

Now, the near-field communication between terminals 10A and 10B as shown in FIG. 2 will be described as an example. Note that terminal 10A will also be referred to as a “first device”, and terminal 10B as a “second device”.

Now, the functions of terminal 10A will be described more in detail.

Terminal 10A includes a processor (e.g., central processing unit (CPU))(not shown) and a memory (not shown) connected to the processor. The processor executes programs using the memory to serve as the following functional part.

FIG. 3 is a block diagram schematically showing a configuration of terminal 10A according to this embodiment.

As shown in FIG. 3, terminal 10A includes communicator 11, near-field communicator 12, processor 13, restrictor 14, and ledger storage 15.

Communicator 11 is a communication interface connected to network N communicatively. Communicator 11 includes a communication interface under a communication protocol suitable for connection to network N. Communicator 11 can include a communication circuit, a communication connector, or a communication antenna which transmits and receives communication signals according to the communication protocol.

Near-field communicator 12 is a communication interface connected between terminals at a physically relatively close distance through wireless communication. Near-field communicator 12 employs a wireless communication protocol, such as Bluetooth (trademark), Wi-Fi (trademark), or infrared data association (IrDA) (trademark). The protocol is however not limited thereto.

Near-field communicator 12 repeatedly transmits predetermined communication signals (e.g., beacon signals) according to the communication protocol to surrounding devices.

Assume that terminals 10A and 10B are located at a distance allowing near-field communication. In this case, near-field communicator 12 receives a predetermined communication signal (e.g., a beacon signal) according to the communication protocol from terminal 10B. Upon receipt, near-field communicator 12 detects that the near-field communication is possible between terminals 10A and 10B, and establish the near-field communication between terminals 10A and 10B.

Processor 13 is a functional part that executes processing related to history information on the processing executed by terminal 10A and the reliability. Processor 13 also executes processing related to transaction data stored in the distributed ledger of ledger storage 15.

Specifically, processor 13 generates transaction data including the history information on the processing executed by terminal 10A and stores the transaction data in the distributed ledgers of terminal 10A and the other terminals. In addition, processor 13 receives transaction data including history information on the processing executed by terminal 10B or 10C and stores the transaction data in the distributed ledger of ledger storage 15. The processing executed by terminal 10A includes, for example, installation of the OS of terminal 1A, establishment of near-field communication, or downloading of content.

Assume that near-field communicator 12 receives identification information identifying terminal 10B through the near-field communication between terminals 10A and 10B. In this case, processor 13 determines the reliability of terminal 10B based on correspondence information with reference to the history information on terminal 10B stored in the storage device.

Here, the identification information identifying terminal 10B allows unique identification of terminal 10B on the distributed ledger. The storage device is ledger storage 15 that stores the distributed ledger. The reliability is the evaluation value indicating the appropriateness of the processing executed by the terminal. The appropriateness of the processing executed by the terminal will also be referred to as an “evaluation”.

The reliabilities are represented by numerical values, for example, within a range from 0% to 100%. Such a case will be described as an example but the representation is not limited thereto. As the reliability, one of predetermined numbers of (e.g., five) values may be selected. The correspondence information indicates information on the types of the processing executed by the terminal and the reliabilities of the terminal in association with each other. A specific example of the correspondence information will be described later.

For example, processor 13 receives history information on installation of the operating system of terminal 10B, as the processing executed by terminal 10B, through the near-field communication. Processor 13 then stores the received history information in the associated distributed ledger. In this case, processor 13 determines a higher evaluation value with an increase in the version of the OS installed by terminal 10B.

For example, processor 13 receives history information on pairing with terminal 10B for the near-field communication, as the processing executed by terminal 10B, through the near-field communication. Processor 13 then stores the received history information in the associated distributed ledger. In this case, processor 13 determines a higher evaluation value with an increase in the total number of partners paired with terminal 10B.

For example, processor 13 receives history information on downloading of content by terminal 10B, as the processing executed by terminal 10B, through the near-field communication. Processor 13 then stores the received history information in the associated distributed ledger. In this case, processor 13 determines a higher evaluation value with an increase in the total number of contents downloaded by terminal 10B.

Note that processor 13 stores transaction data in distributed ledgers in accordance with the types of the distributed ledgers. In addition, processor 13 exchanges communication data with processor 13 of one of terminal 10A and the other terminals via communicator 11. Processor 13 then causes ledger storage 15 of the terminal to store the transaction data. For example, if the distributed ledger is a blockchain, processor 13 generates a block containing new transaction data. Processor 13 then causes ledger storage 15 to store the generated block under a consensus algorithm on the validity of the block among terminal 10A and the other terminals. In this manner, ledger storage 15 stores only blocks whose validity has been successfully confirmed, which reduces unnecessary memory consumption.

Restrictor 14 is a functional part that executes processing related to restriction on the near-field communication with terminal 10B. Specifically, restrictor 14 restricts the near-field communication with terminal 10B based on the evaluation value of terminal 10B as determined by processor 13. The higher the evaluation value of terminal 10B is, the less strict restriction is put on the near-field communication. In other words, the higher the evaluation indicated by the evaluation value of terminal 10B is, the less strict restriction is put on the near-field communication. That is, the higher the evaluation value (i.e., evaluation) on terminal 10B is, the less strictly restrictor 14 restricts the near-field communication. On the other hand, the lower the evaluation value of terminal 10B is, the more strictly restrictor 14 restricts the near-field communication.

Here, the restriction on the near-field communication may include, for example, the restriction on the number of communication frames to be transmitted through the near-field communication. Alternatively, the restriction may include the restriction on the frequency of transmitting communication frames through the near-field communication. That is, the higher the evaluation value of terminal 10B is, the more restrictor 14 eases the restriction on the number of communication frames to be transmitted through the near-field communication. Alternatively, restrictor 14 eases the restriction on the frequency of transmitting communication frames through the near-field communication. On the other hand, the lower the evaluation value of terminal 10B is, the smaller number of communication frames or the less frequently the communication frames are determined by restrictor 14 to be transmitted through the near-field communication. Such restriction on the near-field communication is capable of reducing the processing amount or the resultant power consumption of the processors, such as terminal 10A.

Restrictor 14 may restrict the near-field communication, based on a predetermined threshold. That is, if the evaluation value is higher than the threshold, restrictor 14 may allow the near-field communication with terminal 10b. On the other hand, if the evaluation value is lower than or equal to the threshold, restrictor 14 may deny the near-field communication with terminal 10b. Now, the allowance or denial of the near-field communication by restrictor 14 in accordance with the evaluation value will be described as an example.

Note that restrictor 14 may further cause terminal 10B to store, in the distributed ledger thereof, new history information on processing newly executed by terminal 10B, if the evaluation value is lower than or equal to the threshold.

Restrictor 14 may restrict the execution of related processing, which is related to the near-field communication with terminal 10B, based on the determined evaluation value. Here, the related processing includes the following processing (a), (b), (c), or (d). Processing (a) is reading data stored in the storage device of terminal 10A and transmitting the data to terminal 10B. Processing (b) is writing the data received from terminal 10B to the storage device of terminal 10A. Processing (c) is accessing a sensor or a device of terminal 10A, while the near-field communication with terminal 10B is established. Processing (d) is allowing or denying processing (a), (b), or (c) in advance. Like the case described above, in the restriction on the execution of the related processing, if the evaluation value is higher than a threshold, the execution of the related processing may be allowed. On the other hand, if the evaluation value is lower than or equal to the threshold, the execution of the related processing may be denied. The threshold may be determined in accordance with the following software or processing. The software operates on terminal 10A and communicates with terminal 10B through near-field communication. The processing is executed by terminal 10A and causes near-field communication with terminal 10B. Note that the threshold related to the near-field communication and the threshold related to the execution of the related processing may be different.

Ledger storage 15 is a storage (i.e., storage device) that stores a distributed ledger. The distributed ledger of ledger storage 15 stores one or more transaction data, and is managed based on the characteristics, such as a hash function, to make falsification difficult (which will be described later). Ledger storage 15 stores, in the distributed ledger thereof, the transaction data provided by processor 13. The distributed ledger stores transaction data from the past to the present. The transaction data is managed not to be falsified based on the characteristics that falsification of the information stored in the distributed ledger is difficult,

Note that the distributed ledger is a blockchain, for example. Such a case will be described as an example but any suitable type of a distributed ledger (e.g., IOTA or Hashgraph) may be employed. Note that the distributed ledger may or may not execute a consensus algorithm (e.g., practical byzantine fault tolerance (PBFT)), proof-of-work (PoW) or proof-of-stake (PoS) at the time of storing new data.

Next, reliability correspondence information will be described.

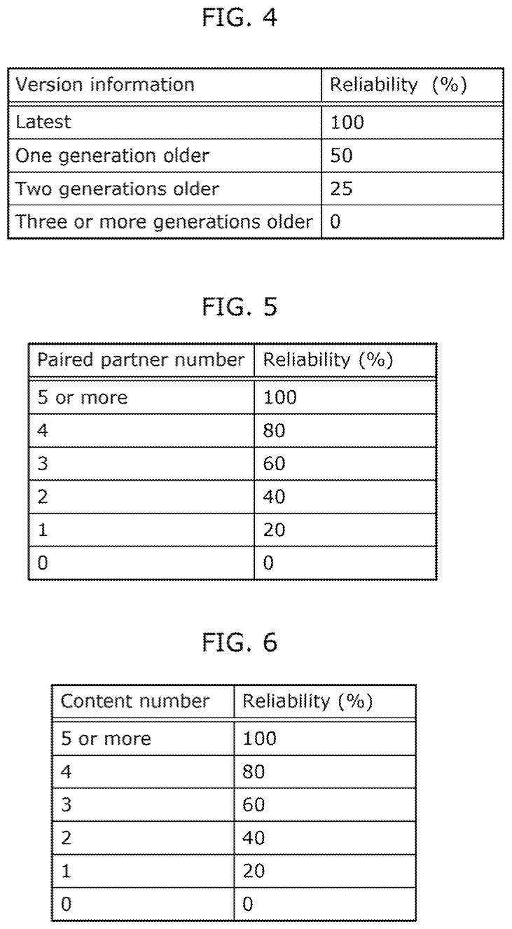

FIG. 4 illustrates a first example of the reliability correspondence information according to this embodiment. The correspondence information shown in FIG. 4 associates the versions of the OS installed by terminal 10B with the reliabilities of terminal 10B. The correspondence information shown in FIG. 4 will also be referred to as “correspondence information A”.

Each entry (i.e., each row) of the correspondence information shown in FIG. 4 indicates version information and a reliability in association with each other.

For example, the version information “Latest” is associated with the reliability of 100%. Based on the information, processor 13 determines 100% as the reliability of terminal 10B that has installed the OS of the latest version.

The version information “One generation older” is associated with the reliability of 50%. Based on the information, processor 13 determines 50% as the reliability of terminal 10B that has installed the OS of a version one generation older (i.e., only one generation older than the latest).

The same applies to the version information “Two generations older” and “Three or more generations older”.

While the terms, such as “Latest”, relatively indicating the versions are used as the version information, terms, such as “version 5.0”, absolutely indicating the versions may be used.

FIG. 5 illustrates a second example of the reliability correspondence information according to this embodiment. The correspondence information shown in FIG. 5 associates the numbers of partners paired with terminal 10B with the reliabilities of terminal 10B. The correspondence information shown in FIG. 5 will also be referred to as “correspondence information B”.

Each entry (i.e., each row) of the correspondence information shown in FIG. 5 indicates the number (expressed as a “paired partner number”) of paired partners and a reliability in association with each other.

For example, the paired partner number “5 or more” is associated with the reliability of 100%. Based on the information, processor 13 determines 100% as the reliability of terminal 10B that has been paired with five or more partners.

The paired partner number “4” is associated with the reliability of 80%. Based on the information, processor 13 determines 80% as the reliability of terminal 10B that has been paired with four partners.

The same applies to the paired partner numbers “3”, “2”, and “1”.

FIG. 6 illustrates a third example of the reliability correspondence information according to this embodiment. The correspondence information shown in FIG. 6 associates the numbers of the contents downloaded by terminal 10B with the reliabilities of terminal 10B. The correspondence information shown in FIG. 6 will also be referred to as “correspondence information C”.

Each entry (i.e., each row) of the correspondence information shown in FIG. 6 indicates the number (expressed as a “content number”) of downloaded contents and a reliability in association with each other.

For example, the content number “5 or more” is associated with the reliability of 100%. Based on the information, processor 13 determines 100% as the reliability of terminal 10B that has downloaded five or more contents.

The content number “4” is associated with the reliability of 100%. Based on the information, processor 13 determines 80% as the reliability of terminal 10B that has downloaded four contents.

The same applies to the content numbers “3”, “2”, and “1”. Now, processing of management system 1 will be described more in detail.

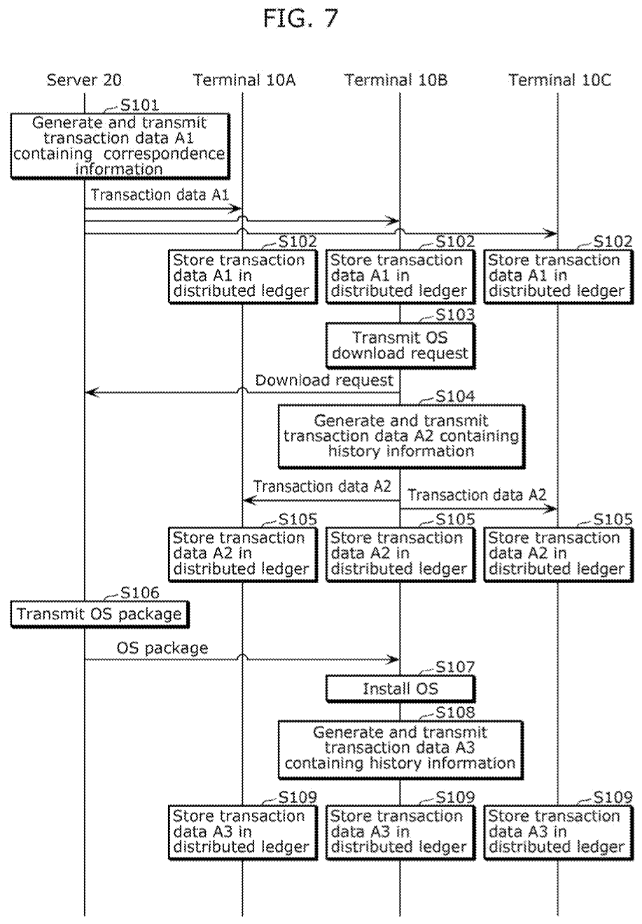

FIG. 7 is a first sequence diagram showing the processing of management system 1 according to this embodiment. FIG. 7 shows the processing of management system 1 related to OS installation by terminal 10B.

In step S101, server 20 generates transaction data (also referred to as “transaction data A1”) containing reliability correspondence information. Server 20 then transmits generated transaction data A1 to terminal 10A and the other terminals. The correspondence information includes correspondence information A (see FIG. 4) indicating OS version information and the reliabilities in association with each other. Each of terminal 10A and the other terminals receives transaction data A1.

In step S102, each of terminal 10A and the other terminals stores, in the distributed ledger thereof, transaction data A1 received in step S101. Terminal 10A and the other terminals may store transaction data A1 in the distributed ledgers thereof under a consensus algorithm. The same applies to the storage of the following transaction data (i.e., transaction data A2 to C2) in the distributed ledgers.

In step S103, terminal 10B transmits an OS download request to server 20. Server 20 receives the download request.

In step S104, terminal 10B generates transaction data (also referred to as “transaction data A2”) containing history information indicating the transmission of the OS download request. Terminal 10B then transmits the generated transaction data to other terminals 10B and 10C. Each of terminals 10B and 10C receives transaction data A2.

In step S105, terminal 10B stores, in the distributed ledger thereof, transaction data A2 generated in step S104. Each of terminals 10A and 10C also stores, in the distributed ledger thereof, transaction data A2 received in step S104.

In step S106, server 20 transmits a set of OS files (also referred to as an “OS package”) to terminal 10B in accordance with the download request received in step S103. Terminal 10B receives the OS package.

In step S107, terminal 10B executes the OS installation utilizing the OS package received in step S106.

In step S108, terminal 10B generates transaction data (also referred to as “transaction data A3”) containing history information indicating the OS installation. Terminal 10B then transmits the generated transaction data to other terminals 10B and 10C. Each of terminals 10B and 10C receives transaction data A3.

In step S109, terminal 101B stores, in the distributed ledger thereof, transaction data A3 generated in step S108. Each of terminals 10A and 10C also stores, in the distributed ledger thereof, transaction data A3 received in step S108.

Assume that server 20 has a distributed ledger. In this case, when transmitting transaction data, terminal 10A and the other terminals transmit the same transaction data to server 20. Similarly, when terminal 10A and the other terminals store transaction data in the distributed ledgers thereof, server 20 stores the same transaction data in the distributed ledger thereof. The same applies to the following.

The series of processing shown in FIG. 7 allows the storage of the history information indicating the OS installation executed by terminal 10B, in the distributed ledgers.

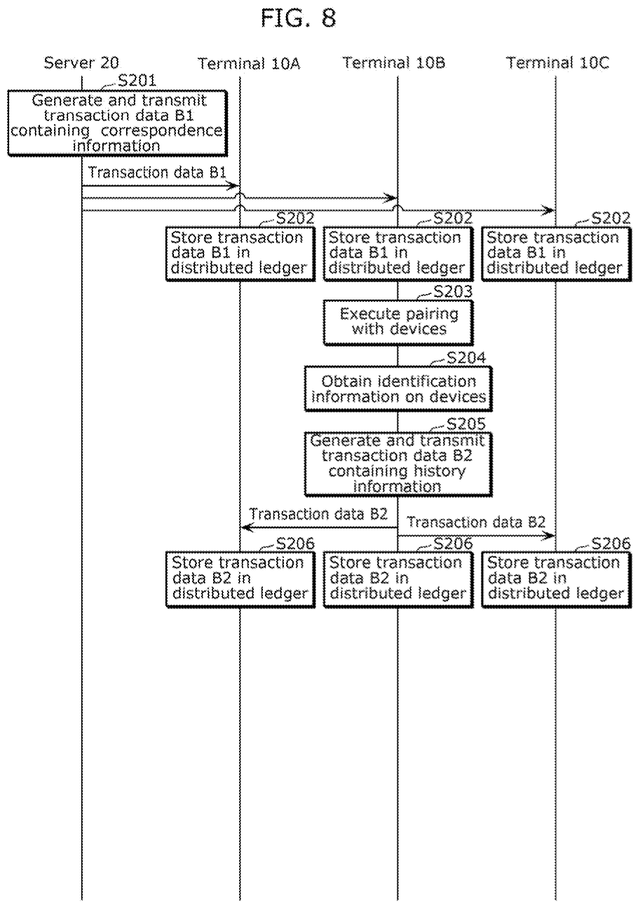

FIG. 8 is a second sequence diagram showing the processing of management system 1 according to this embodiment. FIG. 8 shows the processing of management system 1 related to pairing with terminal 10B for the near-field communication.

In step S201, server 20 generates transaction data (also referred to as “transaction data B1”) containing reliability correspondence information. Server 20 then transmits generated transaction data B1 to terminal 10A and the other terminals. The correspondence information includes correspondence information B (see FIG. 5) indicating the numbers of paired partners and reliabilities in association with each other. Each of terminal 10A and the other terminals receives transaction data B1.

In step S202, each of terminal 10A and the other terminals stores, in the distributed ledger thereof, transaction data B1 received in step S201.

In step S203, terminal 10B executes pairing with other devices through the near-field communication.

In step S204, terminal 10B obtains identification information identifying the devices to be paired from the devices.

In step S205, terminal 10B generates transaction data (also referred to as “transaction data 132”) containing the identification information obtained in step S204, which is the history information indicating the pairing for the near-field communication. Terminal 10B then transmits the generated transaction data to other terminals 10B and 10C. Each of terminals 10B and 10C receives transaction data B2.

In step S206, terminal 10B stores, in the distributed ledger thereof, transaction data B2 generated in step S205. Each of terminals 10A and 10C also stores, in the distributed ledger thereof, transaction data B2 received in step S205.

The series of processing shown in FIG. 8 allows the storage of the history information indicating the pairing for the near-field communication executed by terminal 10B, in the distributed ledgers.

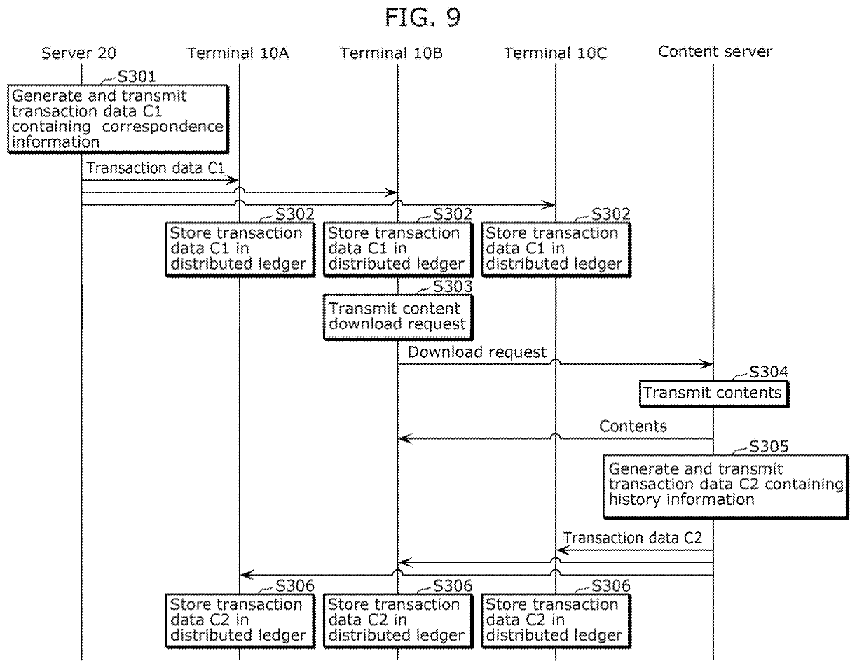

FIG. 9 is a third sequence diagram showing the processing of management system 1 according to this embodiment. FIG. 9 shows the processing of management system 1 related to downloading of content by terminal 10B.

In step S301, server 20 generates transaction data (also referred to as “transaction data C1”) containing reliability correspondence information. Server 20 then transmits generated transaction data C1 to terminal 10A and the other terminals. The correspondence information includes correspondence information C (see FIG. 6) indicating the numbers of downloaded contents and reliabilities in association with each other. Each of terminal 10A and the other terminals receives transaction data C1.

In step S302, each of terminal 10A and the other terminals stores, in the distributed ledger thereof, transaction data C1 received in step S301.

In step S303, terminal 10B generates and transmits a request for downloading of content to a content server. The content server receives the download request.

In step S304, the content server transmits, to terminal 10B, the contents in accordance with the download request received in step S303. Terminal 10B receives the contents.

In step S305, the content server generates transaction data (also referred to as “transaction data C2”) containing history information indicating the downloading of content by terminal 10B. The content server then transmits the generated transaction data to terminals 10A, 10B, and 10C. Each of terminals 10A, 10B, and 10C receives transaction data C2.

In step S306, terminal 10B stores, in the distributed ledger thereof, transaction data C2 generated in step S305. Each of terminals 10A and 10C also stores, in the distributed ledger thereof, transaction data C2 received in step S305.

In place of the processing in step S305, terminal 10B may generate transaction data C2 containing history information indicating the downloading of content and transmit generated transaction data C2 to other terminals 10A and 10C. In this case, each of terminals 10A and 10C receives and stores transaction data C2 in the distributed ledger thereof.

The series of processing shown in FIG. 9 allows the storage of the history information indicating the downloading of content executed by terminal 10B, in the distributed ledgers.

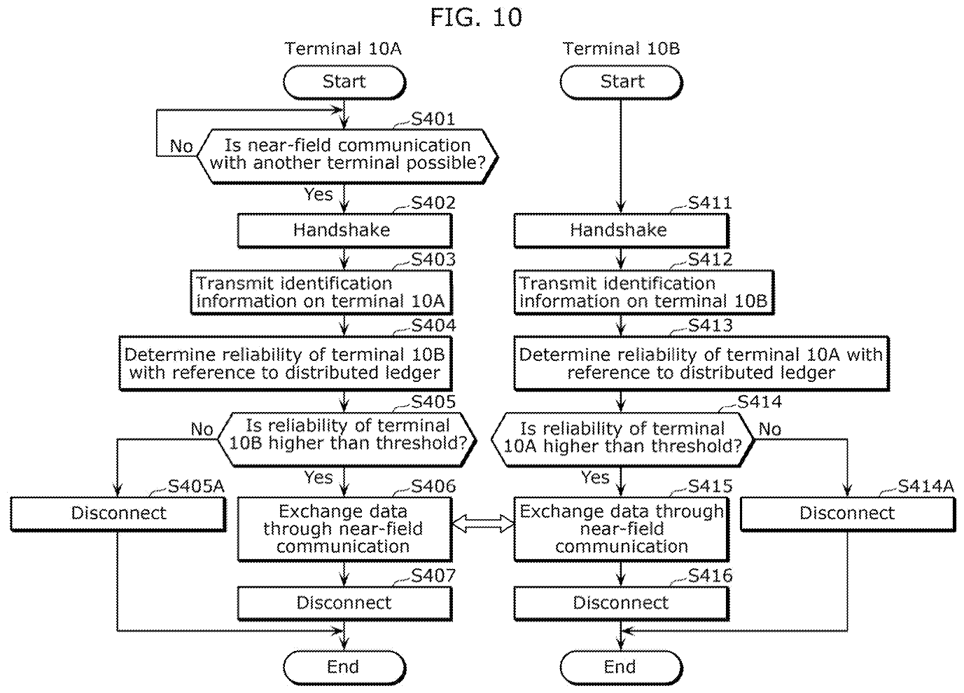

FIG. 10 is a flowchart showing processing of the terminals for the near-field communication according to this embodiment. FIG. 10 shows the flow from when the near-field communication between terminals 10A and 10B is not yet established to when the near-field communication is established and data transfer is executed. The processing shown in FIG. 10 is executed after the storage of the history information indicating the processing executed by terminal 10B in the distributed ledgers, that is, the processing after FIG. 7, 8, or 9.

In step S401, terminal 10A determines whether near-field communication with other terminals is possible. If near-field communication with other terminals is determined to be possible (Yes in step S401), the process proceeds to step S402. If not (No in step S401), step S401 is executed again. That is, terminal 10A stands by in step S401 until near-field communication with other terminals becomes possible.

Here, an example will be described where terminal 10A becomes ready for the near-field communication with terminal 10B, as an example of another terminal, in step S401.

In step S402, terminal 10A executes the establishment of the near-field communication (also referred to as “handshake”, the same applies to the following) with terminal 10B based on the fact that the near-field communication with terminal 10B has become possible in step S401. In step S411, terminal 10B also executes the establishment of the near-field communication with terminal 10A.

In step S403, terminal 10A transmits the identification information identifying terminal 10A to terminal 10B. Terminal 10B receives the transmitted identification information.

In step S412, terminal 10B transmits the identification information identifying terminal 10B to terminal 10A. Terminal 10A receives the transmitted identification information.

In step S404, terminal 10A determines the reliability of terminal 10B with reference to the history information and correspondence information stored in the distributed ledger. In step S413, terminal 10B also determines the reliability of terminal 10A with reference to the history information and correspondence information stored in the distributed ledger.

In step S405, terminal 10A determines whether the reliability of terminal 10B as determined in step S404 is higher than a threshold. If the reliability of terminal 10B is determined to be higher than the threshold (Yes in step S405), the process proceeds to step S406. If not (No in step S405), the near-field communication is disconnected (step S405A) to stop the series of processing shown in FIG. 10. The disconnection of the near-field communication in step S405A is an example of the restriction on the near-field communication by restrictor 14, and corresponds to the denial of the near-field communication when the evaluation value is lower than or equal to the threshold.

In step S414, terminal 10B determines whether the reliability of terminal 10A as determined in step S413 is higher than a threshold. If the reliability of terminal 10A is determined to be higher than the threshold (Yes in step S414), the process proceeds to step S415. If not (No in step S414), the near-field communication is disconnected (step S414A) to stop the series of processing shown in FIG. 10. The disconnection of the near-field communication in step S414A is an example of the restriction on the near-field communication by restrictor 14, and corresponds to the denial of the near-field communication when the evaluation value is lower than or equal to the threshold.

In step S406, terminal 10A exchanges data through the near-field communication with terminal 10B. In step S415, terminal 10B exchanges data through the near-field communication with terminal 10A. The data exchanged in steps S406 and S415 may be restricted by restrictor 14, specifically, the number of communication frames to be transmitted or the transmission frequency may be restricted.

In step S407, terminal 10A disconnects the near-field communication. In step S416, terminal 10B disconnects the near-field communication.

The series of processing shown in FIG. 10 reduces inappropriate communications through the near-field communication.

Now, transaction data will be described.

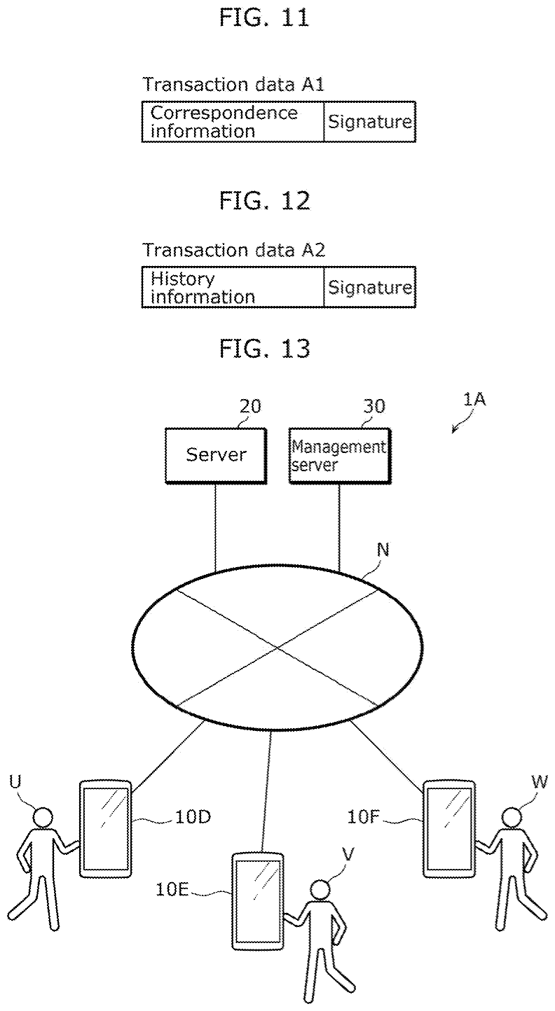

FIG. 11 illustrates transaction data A1 that is a first example of the transaction data according to this embodiment. Transaction data A1 is used for storing, in the distributed ledgers, correspondence information A indicating the OS version information and the reliabilities in association with each other.

As shown in FIG. 11, transaction data A1 contains correspondence information and a signature.

The correspondence information is correspondence information A indicating the OS versions and the reliabilities in association with each other and provided by server 20.

The signature includes a digital signature of the device (i.e., server 20) that has generated transaction data A1.

Note that transaction data B1 containing correspondence information B and transaction data C1 containing correspondence information C have the same configuration as in FIG. 11.

FIG. 12 illustrates transaction data A2 that is a second example of the transaction data according to this embodiment. Transaction data A2 is used for storing, in the distributed ledgers, history information indicating that there is an OS download request.

As shown in FIG. 12, transaction data A2 contains history information and a signature.

The history information indicates that there is an OS download request and is provided by terminal 10B that has transmitted the OS download request.

The signature includes a digital signature of the device (i.e., terminal 10B) that has generated transaction data A2 or user V.

Note that transaction data A3 (in step S108), B2 (in step S205), and transaction data C2 (in step S305) have the same configuration as shown in FIG. 12. Transaction data A3 contains the history information indicating the OS installation by terminal 10B. Transaction data B2 contains the history information indicating the pairing with devices through the near-field communication. Transaction data C2 contains the history information indicating the content provision to terminal 10B.

Note that terminal 10A and the other terminals generate transaction data containing the following information related to the processing executed by terminal 10A and the other terminals, for example. Each terminal may then store the generated transaction data in the distributed ledger thereof.
(1) Information indicating upgrade of firmware of pairing terminal (e.g., heart rate monitor)

This information verifies that the OS version of the terminal body is updated to a version which is higher than or equal to the version requested by the pairing terminal. Note that a higher reliability can be determined with an increase in the version of the firmware of the pairing terminal.
(2) Number of pairing terminals requiring user authentication

For example, a wearable terminal is associated with a user ID and thus counted one. On the other hand, Bluetooth (BLE) earphones require no ID and are thus not counted. A higher possibility that a terminal is owned by a specific individual (i.e., not rented) is ensured with an increase in the number of accounts associated with the terminal. Note that a higher reliability is determined with an increase in the number of pairing terminals (e.g., wearable terminals) requiring user authentication. Pairing terminals (e.g., BLE earphones) requiring no user authentication are not necessarily reflected on the reliabilities. Note that the number of unauthorized logs of upload by pairing terminals may be employed. For example, an unauthorized log may be determined by a heart rate. A higher reliability is determined with a decrease in the number of fraud detections.
(3) Number of alerts issued by an external fraud detection system against logs of upload by pairing terminals

Based on the number, unauthorized use or malfunction related to the reliability of data uploaded by a device is recorded.
(4) Number of packets of other terminals transferred by host terminal through multi-hop communication

The number shows a higher contribution of the terminal, which establishes an ad hoc network, to the network traffic. Note that a higher reliability is determined with an increase in the number of packets of other terminals transferred through multi-hop communication.
(5) User, manager, administration, or manufacturer of terminal (incl. updates, additions, or information indicating “unknown”)

Based on the fact that there is a correlation between the reliability of the security of the device itself and the social credibility. This is in view of security maintenance costs or device management. Note that a higher reliability can be determined with an increase in the credibility of the user, manager, administration, or manufacturer of the terminal.
(6) Start time of using terminal or frequency of use

This is because a terminal used frequently is believed to have ensured a certain level of security at the start of using another application or service. Note that, a higher reliability can be determined at an earlier start time of using the device. A higher reliability can be determined with an increase in the frequency of using the terminal.
(7) Names and number of applications installed in terminal and number of downloaded applications

The names of applications are used to refer to a blacklist of harmful applications or a whitelist of allowable applications. Note that a higher reliability can be determined with a decrease in the number of downloaded applications. Alternatively, if a download application is included in the blacklist, a relatively low reliability is determined. On the other hand, if a downloaded application is included in the whitelist, a relatively high reliability is determined.

Note that terminal 10A and the other terminals may determine reliabilities as follows.
(1) Deduct difference of firmware version of pairing terminal from latest version.

For example, assume that the version of terminal 10A is two generations older than the latest, while the version of terminal 10B is ten generations older than the latest. In this case, the reliability is calculated as: perfect score 100−(2+10)=88. This is because, without updating, known vulnerability remains.
(2) Regard percentage of pairing terminals, which have already upgraded to the latest firmware, as reliability.

This is because, without updating, known vulnerability remains.
(3) Make the reliability inversely proportional to a deviation of a vital log uploaded by the terminal of a pairing terminal.

For example, a large deviation from a normal heart rate log does not necessarily mean that a specific individual wears the device. A lower reliability is thus determined. Alternatively, different blood pressures (top and bottom) are transmitted multiple times within a certain time period (i.e., large deviations) means that incorrect measurement. A lower reliability is thus determined. If vital logs are used for biometric authentication, there is a need to secure the stability in obtaining the logs using the host device (incl. state of wearing of the pairing device).
(4) In communication with an unfamiliar terminal, a lower reliability is determined.

A higher reliability is determined with an increase in the number of communication experiences. This is because a terminal used frequently is believed to have ensured a certain level of security at the start of using another application or service.
(5) Make the reliability proportional to the reliability of the user, manager, administration, or manufacturer.

Based on the fact that there is a correlation between the reliability of the security of the host device itself and the social credibility. This is in view of security maintenance costs or device management.
(6) Make the reliability proportional to the reliability of installed application.
(7) Make the reliability inversely proportional to the reliability of installed application.

The risk of an inappropriate application is taken into consideration.
(8) Make the reliability proportional to the reliabilities of past communication partners.

Communications with suspicious servers increase the security risk in the host device.
(9) Determine a higher reliability with an increase in the number of requirements (1) to (8) met.

Note that terminal 10A and the other terminals may utilize the reliabilities.
(1) Only terminals with high reliabilities can establish an ad hoc network. Established by highly reliable terminals, a network without attackers can be used for exchanging confidential information, while sharing threat information.
(2) Only terminals with high reliabilities can establish a blockchain network. Established by highly reliable terminals, a network without attackers can be used for exchanging confidential information, while sharing threat information.
(3) Assume that a host terminal makes a handshake with another terminal with a lower reliability than the host terminal. In this case, the host terminal notifies the provider of the application version that may influence the reliability or distribute the application version and receives an incentive from the provider. The servicer cannot distribute the application without any active request through the Internet but can distribute the application by other communication means (e.g., near-field communication).
(4) The reliability of a terminal is partially reflected when calculating the reliability of data obtained by the terminal.
(5) Provide different rewards in terms of quality or quantity. For example, rewards are paid to a user with a relatively high reliability in US dollars or Japanese yen. Rewards are paid to a user with an intermediate reliability in bitcoin. Rewards are paid to a user with a relatively low reliability in virtual currency other than bitcoin (what is called “shitcoin”).
(6) Make the request “No access is allowable. Provide more credible evidence.”
(7) A suspicious device may receive some questions or cause a delay in procedure.

### Variation of Embodiment

In this variation, another example of the management system for reducing inappropriate communications through near-field communication will be described. In the embodiment described above, the correspondence information and the history information are stored in the distributed ledgers. Instead, an example will be described in this variation where correspondence information and history information are stored in a storage device of a management server.

FIG. 13 schematically illustrates a configuration of management system 1A according to this variation.

As shown in FIG. 13, management system 1A includes terminals 10D, 10E, and 10F (also referred to as “terminal 10D and the other terminals”) and management server 30. As in the embodiment described above, management system 1A is connected to server 20.

Terminal 10D and the other terminals are similar to terminal 10A and the other terminals according to the embodiment. Unlike terminal 10A and the other terminals, the terminals have no distributed ledger.

Management server 30 is a server device that manages the reliabilities of terminal 10D and the other terminals. Management server 30 includes the storage device. The storage device stores management information and history information. That is, the information stored in the storage device of management server 30 is the same as those stored in the distributed ledgers according to the embodiment described above.

Server 20, terminal 10D, and the other terminals store management information or history information in the storage device as follows. Server 20, terminal 10D, and the other terminals transmit the management information or the history information to management server 30, and cause the storage device of management server 30 to store the management information or the history information.

Server 20, terminal 10D, and the other terminals obtain management information or history information as follows. Server 20 and terminal 10D transmit, to management server 30, a request for reading out the management information or the history information, and obtain the management information or the history information read out by management server 30 in accordance with the request.

Terminal 10D and the other terminals have configurations similar to those of terminal 10A and the other terminals. Unlike terminal 10A and the other terminals, processor 13 performs no processing related to transaction data. In addition, unlike terminal 10A and the other terminals, terminal 10D and the other terminals include no ledger storage 15.

Now, processing of management system 1A will be described.

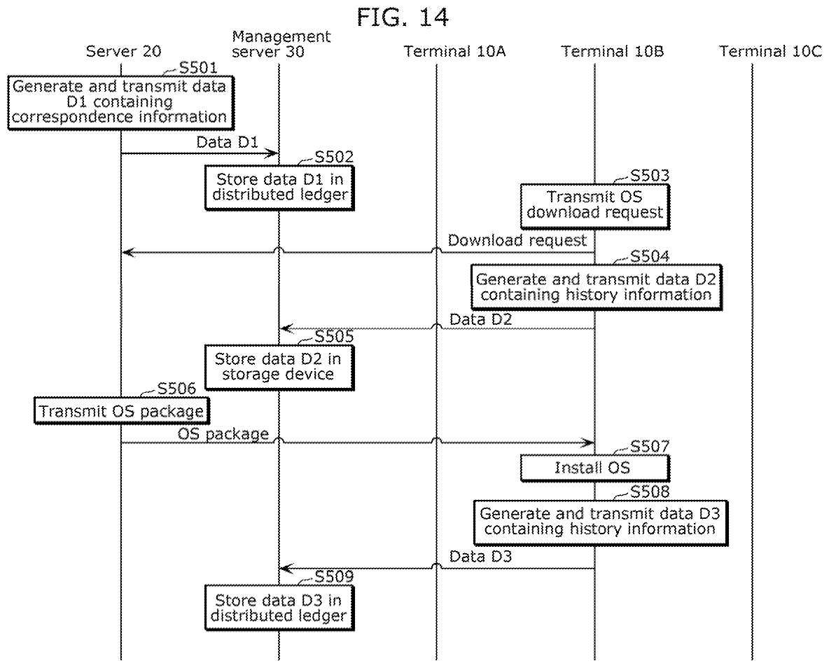

FIG. 14 is a sequence diagram showing processing of management system 1A according to this variation. FIG. 14 shows the processing of management system 1A related to the OS installation by terminal 10E.

In step S501, server 20 generates data (also referred to as “data D1”) containing reliability correspondence information. Server 20 then transmits generated data D1 to management server 30. The correspondence information includes correspondence information A (see FIG. 4) indicating the OS versions and reliabilities in association with each other. Management server 30 receives data D1.

In step S502, management server 30 stores, in the storage device thereof, data D1 received in step S501.

In step S503, terminal 10E transmits an OS download request to server 20. Server 20 receives the download request.

In step S504, terminal 10E generates data (also referred to as “data D2”) containing history information indicating the OS download request. Terminal 10E then transmits the generated data to management server 30. Management server 30 receives data D2.

In step S505, management server 30 stores, in the storage device thereof, data D2 received in step S504.

In step S506, server 20 transmits an OS package to terminal 10E in accordance with the download request received in step S103. Terminal 10E receives the OS package.

In step S507, terminal 10E executes the OS installation, utilizing the OS package received in step S506.

In step S508, terminal 10E generates data (also referred to as “data D3”) containing history information indicating the OS installation. Terminal 10E then transmits the generated data to management server 30. Management server 30 receives data D3.

In step S509, management server 30 stores, in the distributed ledger thereof, data D3 received in step S508.

The series of processing shown in FIG. 7 allows the storage of the history information indicating the OS installation executed by terminal 10E, in the storage device of management server 30.

Similarly, the history information on the pairing for the near-field communication or on the downloading of content can also be stored in the storage device of management server 30.

Assume that terminals 10D and 10E establish near-field communication. In this case, each terminal determines the reliability of the partner terminal, with reference to the history information and correspondence information stored in the storage device of management server 30 in place of the distributed ledger in steps S404 and S413. The device then executes the subsequent processing.

The information obtained, generated, or transmitted by management system 1 in the embodiment or variation may be stored in a distributed ledger or displayed on a display of terminal 10A or another terminal. For example, the display may indicate restriction on the near-field communication or display any information on a terminal whose access has been denied.

The series of processing allows management system 1A to reduce inappropriate communications through the near-field communication.

### Supplementary Description

The distributed ledgers in the embodiment or variation will be described supplementarily. While a blockchain will be described here as an example of a distributed ledger, the same applies to other types of distributed ledgers.

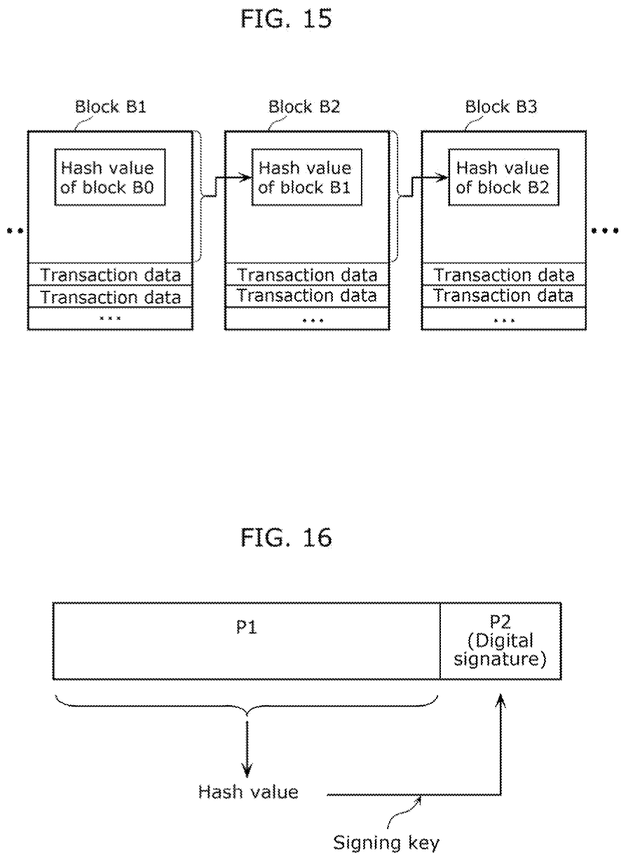

FIG. 15 illustrates a data structure of the blockchain.

The blockchain is obtained by connecting blocks, which are recording units, in a chain. Each block includes a plurality of transaction data and the hash value of a block immediately before the block. Specifically, block B2 includes the hash value of block B1 immediately before block B2. The hash value calculated from the plurality of transaction data contained in block B2 and the hash value of block B1 are included as the hash value of block B2 in block B3. In this manner, the blocks are connected in a chain, while including the contents of the previous blocks as hash values, to effectively reduce the falsification of the recorded transaction data.

If past transaction data is changed, the hash value of a block is different from that before the change. In order to make the falsified block look like the correct one, there is a need to recreate all the subsequent blocks. This work is practically extremely difficult. With this feature, the difficulty in the falsification of the blockchain is ensured.

FIG. 16 illustrates a data structure of transaction data.

The transaction data shown in FIG. 16 contains transaction body P1 and digital signature P2. Transaction body P1 is a data body contained in the transaction data. Digital signature P2 is generated by signing the hash value of transaction body P1, using a signing key of the generator of the transaction data. Specifically, the signature is generated by encrypting the hash value, using a secret key of the generator.

Since the transaction data contains digital signature P2, falsification is substantially impossible. This configuration reduces the falsification of the transaction body.

As described above, in the control method according to the embodiment and variation, the first device restricts the near-field communication with the second device, based on the appropriateness of the processing executed by the second device. This configuration reduces the risk of leaking information through transmission to the second device that has executed inappropriate processing. This configuration also reduces the risk of causing the first device to operate inappropriately upon receipt of the information from the second device that has executed inappropriate processing. On the other hand, the first device operates appropriately through communications via the second device that has executed appropriate processing. In this manner, the first device reduces inappropriate communications through the near-field communication.

The first device restricts the near-field communication with the second device more strictly with a decrease in the appropriateness of the processing executed by the second device. This configuration reduces the risk of leaking information through transmission to the second device that has executed inappropriate processing. This configuration also reduces the risk of causing the first device to operate inappropriately upon receipt of the information from the second device that has executed inappropriate processing. On the other hand, the first device restricts the near-field communication with the second device more moderately with an increase in the appropriateness of the processing executed by the second device. Accordingly, the first device operates appropriately through communications via the second device that has executed appropriate processing. In this manner, the first device reduces inappropriate communications through the near-field communication.

The first device allows or denies the near-field communication with the second device more easily, based on the threshold. Accordingly, the first device restricts inappropriate communications through the near-field communication more easily.

The first device determines the evaluation value of the second device more easily, based on the version of the operating system installed by the second device. Accordingly, the first device restricts inappropriate communications through the near-field communication more easily.

The first device determines the evaluation value of the second device more easily, based on the number of the partners paired with the second device for the near-field communication. Accordingly, the first device restricts inappropriate communications through the near-field communication more easily.

The first device determines the evaluation value of the second device more easily, based on the number of the contents downloaded by the second device. Accordingly, the first device restricts inappropriate communications through the near-field communication more easily.

The first device restricts the related processing, based on the appropriateness of the processing executed by the second device. Accordingly, the first device contributes to the reduction in inappropriate operations of the first device itself, while restricting inappropriate communications through the near-field communication.

The first device allows or denies the execution of the related processing more easily, based on the threshold. Accordingly, the first device contributes to the reduction in inappropriate operations of the first device itself, while restricting inappropriate communications through the near-field communication.

The first device allows or denies the execution of the related processing more easily, based on the threshold determined in accordance with the software or processing communicating with the second device through the near-field communication. Accordingly, the first device contributes to the reduction in inappropriate operations of the first device itself, while restricting inappropriate communications through the near-field communication.

The first device may cause the second device that has executed inappropriate processing to store new history information so as to increase the appropriateness of the processing executed by the second device. In this case, the first device may allow the near-field communication with the second device. Accordingly, the first device has more opportunities to communicate with the second device through the near-field communication. The first device reduces inappropriate communications through the near-field communication and has more opportunities for appropriate communications.

The first device evaluates the appropriateness of the processing executed by the second device, based on the evaluation value safely managed using the distributed ledger substantially without any falsification. The first device then restricts the near-field communication with the second device. Accordingly, the first device reduces inappropriate communications through the near-field communication, based on the evaluation value managed more safely.

In the embodiment described above, the consistent elements may be dedicated hardware or may be achieved by executing software programs suitable for the consistent elements. The constituent elements may be program executors, such as a CPU or a processor, which read out software programs stored in a recording medium, such as a hard disk or a semiconductor memory, and executes the read-out programs. Here, the content management system according to the embodiment described above is achieved by the following program.

Specifically, this program is for causing a computer to execute a control method to be executed by a first device. The control method includes: receiving identification information identifying a second device from the second device through near-field communication; determining an evaluation value indicating appropriateness of processing executed by the second device, with reference to a storage device that stores history information indicating the processing executed by the second device; and restricting the near-field communication with the second device, based on the evaluation value determined.

While the management system, for example, according to one or more aspects has been described above based on the embodiment, the present disclosure is not limited to this embodiment. One or more aspects may include forms obtained by various modifications to the foregoing embodiment that can be conceived by those skilled in the art or forms achieved by freely combining the constituent elements in the foregoing embodiment without departing from the scope and spirit of the present disclosure.

### INDUSTRIAL APPLICABILITY

The present disclosure is applicable to a management system for reducing inappropriate communications through near-field communication.

1. A control method to be executed by a first device, the control method comprising:
receiving identification information identifying a second device from the second device through near-field communication;
determining an evaluation value indicating appropriateness of processing executed by the second device, with reference to a storage device that stores history information indicating the processing executed by the second device; and
restricting the near-field communication with the second device, based on the evaluation value determined.

2. The control method according to claim 1, wherein
the higher an evaluation indicated by the evaluation value is, the less strict the restriction is.

3. The control method according to claim 2, wherein
the restricting includes:
allowing the near-field communication with the second device, when the evaluation value is higher than a threshold; and
denying the near-field communication with the second device, when the evaluation value is lower than or equal to the threshold.

4. The control method according to claim 1, wherein
the processing includes installation of an operating system by the second device, and
the determining includes:
determining a higher evaluation value with an increase in a version of the operating system installed in the installation by the second device.

5. The control method according to claim 1, wherein
the processing includes pairing for the near-field communication by the second device, and
the determining includes:
determining a higher evaluation value with an increase in a total number of partners paired with the second device.

6. The control method according to claim 1, wherein
the processing includes downloading of content by the second device, and
the determining includes:
determining a higher evaluation value with an increase in a total number of contents downloaded by the second device.

7. The control method according to claim 1, further comprising:
restricting execution of related processing that is related to the near-field communication with the second device, based on the evaluation value determined, wherein
the related processing includes:
(a) reading data stored in a storage device of the first device, and transmitting the data to the second device;
(b) writing the data received from the second device to the storage device of the first device;
(c) accessing a sensor or a device of the first device, while the near-field communication with the second device is established; and
(d) allowing or denying (a), (b), or (c) in advance.

8. The control method according to claim 7, wherein
the restricting of the execution of the related processing includes:
allowing the execution of the related processing, when the evaluation value is higher than a threshold; and
denying the execution of the related processing, when the evaluation value is lower than or equal to the threshold.

9. The control method according to claim 3, wherein
the threshold is determined in accordance with software that is operating on the first device and communicating with the second device through the near-field communication, or processing that is executed by the first device and communicating with the near-field communication with the second device.

10. The control method according to claim 3, further comprising:
causing the storage device to store new history information on processing newly executed by the second device, when the evaluation value is lower than or equal to the threshold.

11. The control method according to claim 1, wherein
the first device and the second device are included in a plurality of devices each having a distributed ledger for managing the history information,
the first device includes the storage device, and
the determining includes:
determining the evaluation value with reference to the history information stored in the storage device of the first device.

12. A control device that serves as a first device, the control device comprising:
a processor; and
a memory connected to the processor, wherein
using the memory, the processor
receives identification information identifying a second device from the second device through near-field communication,
determines an evaluation value indicating appropriateness of processing executed by the second device, with reference to a storage device that stores history information indicating the processing executed by the second device; and
restricts the near-field communication with the second device, based on the evaluation value determined.

13. A non-transitory computer-readable recording medium for use in a computer, the recording medium having recorded thereon a program for causing the computer to execute the control method according to claim 1.
